(19) United States
(12) Patent Application Publication
(10) Pub. No.: US 2014/0371126 A1
(43) Pub. Date: Dec. 18, 2014

(54) Laundry detergent compositions comprising soil release agent

(71) Applicants: Klin Aloysius Rodrigues, Signal Mountain, TN (US); Daniel Woodson Verstrat, Ooltewah, TN (US); Allen Mark Carrier, Hixson, TN (US); Martin Charles Crossman, Bebington (GB); Adam Peter Jarvis, Bebington (GB); Susanne Henning Rogers, Bebington (GB)

(72) Inventors: Klin Aloysius Rodrigues, Signal Mountain, TN (US); Daniel Woodson Verstrat, Ooltewah, TN (US); Allen Mark Carrier, Hixson, TN (US); Martin Charles Crossman, Bebington (GB); Adam Peter Jarvis, Bebington (GB); Susanne Henning Rogers, Bebington (GB)

(73) Assignee: Akzo Nobel Chemicals international B.V., MH Amersfoort (NL)

(21) Appl. No.: 14/241,151

(22) PCT Filed: Aug. 28, 2012
(86) PCT No.: PCT/EP2012/066635

§ 371 Date: Apr. 11, 2014

Related U.S. Application Data
(60) Provisional application No. 61/529,467, filed on Aug. 31, 2011.
(60) Provisional application No. 61/529,457, filed on Aug. 31, 2011.

(51) Int. Cl. C11D 3/00; C11D 3/37

(52) U.S. Cl. CPC C11D 3/0036; C11D 3/37
USPC 510/392; 510/400

(57) ABSTRACT

A detergent composition comprising 10 to 60 wt % detergent surfactant and 0.1 to 10 wt % of a soil release agent comprising a water soluble addition polymer having a backbone prepared from (meth)acrylic, vinylic and/or (meth)acrylamido and pendent di- and/or tri-styryl groups attached thereto.

### TECHNICAL FIELD

This invention relates to various detergent and/or cleaning compositions comprising soil release agent. It relates particularly to compositions comprising detergent surfactant and a soil release polymer (SRP) which is a water soluble addition polymer comprising an acrylic (vinylic) backbone with hydrophobic pendent groups attached thereto.

### BACKGROUND

There is a desire to make laundry detergent compositions of reduced dose per wash in order to further reduce environmental impact from the manufacture and distribution of detergent compositions. SRP is advantageously included in a reduced dose laundry detergent composition due to its high impact per unit weight. Polymers based on polyester chemistry are known to hydrolyse under alkaline conditions and this can make them much less effective than expected after prolonged storage in a laundry detergent composition. Acrylic based polymers do not suffer from hydrolysis, but their effectiveness as SRPs under alkaline conditions is generally poor.

Acrylic polymers have been proposed in GB1407013A to be used in a laundry rinse conditioner to be deposited from the acidic conditions that it is used under. It is believed that in this case the polymer ends up on the fabric mainly by filtration as the rinse water passes through the fabric. Under alkaline conditions these polymers would have sufficient charge to repel them from a polyester fabric and thus the extent of deposition would be insignificant. Similar teachings are found in U.S. Pat. No. 3,798,169, which describes methacrylic acid/ethyl acrylate polymers giving soil release when applied in the rinse cycle.

Acrylic based copolymers with alkyl ethoxylate pendent groups are known as thickeners in laundry detergents. See, for example, EP217485, U.S. Pat. No. 4,429,097, and EP859796. Other uses of acrylic copolymers, including acrylic styrene copolymers are described in U.S. Pat. No. 5,820,637 and in EP 0786517.

A tristyryl methacrylate is available from Rhodia under the trade name Sipomer SEM 25. This is described as Polyethylene glycol methacrylate tristyrylphenyl ether. The following publications describe the theoretical option to use this monomer in a polymer that may be used for household care or laundry compositions. No such polymers are actually made or form any of the examples in these documents: WO 2010/046342, US 2010/0093929, US 2010/0004152, US 2009/0197791, WO 2007/017098, US 2010/0120637, US 2008/0281064, US 2008/0255289, US 2007/0274942, FR 2853324, US 2007/0094809, US 2006/0217285, US 2005/0097678, US 2005/0028293, US 2003/0050218, US 2002/0065208; US 2004/0038851, US 2006/0211594, US 2003/0109413 and US 2009/0165216.

U.S. Pat. No. 4,240,918 uses a tristyryl end group in a urethane or polyester for laundry. Polyurethanes and polyesters only have the potential to use limited tristyryl functionality.

WO 2010/127809 discloses cleaning compositions containing comb polymers having a methacrylic chain with pendant groups including tristyrylphenol polyethoxylate with 10-30 EO units (p 6 line 15). Example 6 discloses a polymer using tristyryl phenol 20EO. This is a condensation polymer. As a condensation polymer it would suffer from hydrolytic instability in many laundry detergent compositions.

U.S. Pat. No. 7,470,290 (Clorox) discloses a hard surface cleaning composition with a “next-time cleaning benefit” by applying a hydroscopic polymer to a surface.

The polymer may include a tristyryl phenol-capped polyethylene oxide ester of methacrylic acid (column 20 line 57 and claim 21).

WO 2008/060997 (Lubrizol) discloses a method of increasing the cmc of a surfactant composition with a hydrophobically modified (meth)acrylic polymer.

Suitable hydrophobic units include the associative monomer tristyrylphenol polyethoxylated (meth)acrylate (p15).

WO 2005/092276 (Noveon) discloses household care products containing an amphoteric surfactant and an acid-swellable cationic associative polymer comprising of amino-substituted vinyl monomers, hydrophobic nonionic vinyl monomers, associative vinyl monomers (tristyrylphenol polyethoxylated (meth)acrylate) and semi hydrophobic vinyl surfactant monomers.

WO 2004/024779 (Noveon) discloses polymers for use in household care compositions comprising 4 monomer units including an associative vinyl monomer which can be tristyrylphenol polyethoxylated methacrylate.

US 2003/0207988 (Noveon) and US 2008/0045646 discloses household care formulations (claim 28) containing associative polymers comprising 4 monomer units and a cross linking agent. One of these monomers can be tristyrylphenol polyethoxylated methacrylate (para 69).

U.S. Pat. No. 5,721,313 (Rhone-Poulenc) discloses detergent compositions comprising a water-in-oil polymer emulsion which is the reaction product of four monomers and a cross linking agent. Monomer “d” is an ethylenically unsaturated species which can be tristyryl phenol polyethylene oxide methacrylate (column 3 line 35).

U.S. Pat. No. 5,650,473 (assigned to Akzo) discloses the synthesis and use of hydrophobic styrene copolymers. The hydrophobic copolymers were found to be particularly useful in laundry applications.

There remains a need for laundry detergent compositions comprising a SRP with excellent hydrolytic stability due to the absence of unstable ester bonds and yet providing the good soil release properties characteristic of SRPs having such ester bonds as part of their fabric recognition motif when used in a laundry process.

### SUMMARY OF THE INVENTION

According to the present invention there is provided a detergent composition comprising 10 to 60 wt % of a surfactant system and 0.1 to 10 wt % of a soil release agent comprising a water soluble addition polymer having an acrylic (vinylic) backbone and pendent di- and/or tri-styryl groups attached thereto.

Preferably the groups are tri-styryl groups and are attached to the backbone via spacer groups comprising from 8 to 100 alkylene oxide groups, preferably ethylene oxide (“EO”) groups.

Preferably the amount of soil release agent comprises at least 0.3 wt %, more preferably at least 0.5 wt %.

The detergent composition may be solid or liquid. Solid formats include powders, granules, compressed tablets and large extruded particles. Liquid formats include so called non aqueous liquids having less than 25 wt % water, typically contained in a soluble film pouch for direct dosing to a washing process, and free flow liquids in liquid form, including gels. Aqueous alkaline liquid compositions are particularly preferred as they can take full advantage of the combination of alkaline stability and good soil release performance of the polymers used in the compositions according to the invention.

### DETAILED DESCRIPTION OF THE INVENTION

The laundry detergent composition may be in either solid or liquid form. Liquids may include some solid particles in the liquid; the solid particles may be suspended or not suspended in the liquid. Suspension may be achieved by an external structurant or by means of high viscosity, for example.

When the laundry detergent composition is in solid form it preferably further comprises at least 5 wt % of a builder system builder. The preferred builder system comprises a major part of sodium carbonate.

When the laundry detergent composition is in liquid form it is preferably capable of forming an alkaline wash liquor when diluted at least 500 times with domestic water.

The preferred surfactant system for the composition comprises linear alkylbenzene sulphonate, optionally in admixture with an ethoxylated alcohol nonionic surfactant. The composition may further comprise a cleaning polymer, for example an ethoxylated polyethylene imine (EPEI). It may further comprise one of more enzymes such as protease, amylase, cellulase, lipase, mannanase, preferably protease and may yet further comprise one or more of fluorescer, bleach, bleach catalyst, colorant, perfume, sequestrants, antioxidant, care additives such as silicones, pH adjusting agents and buffers.

Preferred acrylic SRPs for use in the detergent compositions are made with the monomers: tristrylphenol ethoxylate methacrylate (TSPEOMA), or distrylphenol ethoxylate methacrylate (DSPEOMA), tertiary butyl amino ethyl methacrylate (TBAEMA), ethyl hexyl acrylate (EHA), N,N,dimethylacrylamide (NNDMA), hydroxyethyl acrylate (2-HEA), Methyl methacrylate (MMA), and methacrylic acid (MAA).

TBAEMA and EHA are hydrophobic monomers that may be added to the polymer in minor amounts of up to 30 mol % to adjust its solubility. The backbone is preferably a copolymer of the TSPEOMA. TSPEOMA may be fully or partially substituted with DSPEOMA. The amount of the di- and tri-styryl monomers may vary from as little as 2 mol % to 50 mol %, and is preferably at least 5 mol %. Some exemplary polymers are (with mol % in parentheses):

1) TSPEOMA (5), TBAEMA (20), NNDMA (75)

2) TSPEOMA (20), EHA (20), NNDMA (30), 2-HEA (30)

3) TSPEOMA (40), NNDMA (60)

4) TSPEOMA (40), MAA (60)

5) TSPEOMA (20), EHA (20), MAA (60)

6) TSPEOMA (40), MMA (30), MAA (30)

7) TSPEOMA (36), NNDMA (32), MAA (32)

8) TSPEOMA (30), NNDMA (30), MAA (40)

Laundry detergent compositions comprising the acrylic polymers combine the expected enhanced stability in alkaline environments with a surprisingly good soil release performance on textiles comprising cotton and/or polyester and detergency on a range of stains and cloths.

The acrylic backbone confers solubility to the polymer. The tristyryl group is a large hydrophobic group that does not interact with surfactant. It is kept away from the backbone by use of a spacer group. The spacer is an alkylene oxide group, typically EO based and typically lies in the range 8EO to 100EO for example 16EO or 25EO. It could be partially or completely PO, or any lower alkoxy. The polymers are addition polymers and they are preferably formed by reacting a mix comprising the (meth)acrylate of TSP-EO, for example Sipomer 25.

The vinylic/acrylic radical polymers can include substantially more tristyryl groups than the prior art tristyryl urethanes and polyesters. Furthermore the polymers according to the invention may incorporate additional functionality into the backbone. The additional backbone functionality may be anionic, for example carboxylic, sulphonic; nonionic-hydrophilic, for example hydroxy, ethoxy; nonionic-hydrophobic, for example methyl, lauryl, stearyl; cationic for example amino, quaternary.

The inclusion of a tristyryl phenyl moiety as a pendent functional group on a water-soluble or water-dispersible polymeric vinylic backbone in a laundry detergent composition has shown improved primary detergency on enzymatic sensitive stains, improved primary detergency on hard fats (lipstick), soil release effect for sebum, lipstick; i.e. enhanced cleaning on collar stains, and grass stains).

The polymers show effect on both polyester and cotton. The polymers have been found to provide improved primary detergency and a soil release effect versus Texcare® SRN170, an exemplary polyester based SRP. The improvement versus this SRP was surprising. Whilst it was expected the polymers based on acrylate addition polymers would have much improved stability, it was thought that they would also have lower soil release performance, when compared to the unstable but high performing polyester based polymers of the prior art.

Another benefit of the compositions claimed is that the SRP seems to persist at the fabric interface and is not removed by the surfactant system as easily as is the case with detergent compositions comprising prior art polyester based polymers.

The invention will now be further described by way of the following non-limiting examples.

### EXAMPLES

In the examples the following materials are used:
LAS acid is C12-14 linear alkylbenzene sulphonic acid.
Fatty acid is coco acid.
SLES 3EO is sodium lauryl ether sulphate with 3 moles EO.
NI 7EO is C12-15 alcohol ethoxylate 7EO nonionic Neodol® 25-7 (ex Shell Chemicals).
MPG is mono propylene glycol.
NaOH is sodium hydroxide (from 47% solution).
SRP is soil release polymer as specified in Table 1.
Perfume is free oil perfume.

TABLE 1
SRPs

| | Monomer (mol %) | | | | | | |
|---|---|---|---|---|---|---|---|
| | | | Co | Co | | | Polymer |
| Polymer | TSPEOMA | Hydrophobe | monomer 1 | monomer 2 | solids % | Mw | activity |
| 1 | 5 | 20 TBAEMA | 75 | 0 | 17.05 | 80k | 100% |
| | 25EO | | NNDMA | | | | |
| 2 | 20 | 20 EHA | 30 | 30 | 23.51 | 49k | 85% |
| | 25EO | | NNDMA | 2-HEA | | | |
| 3 | 40 | 0 | 60 | 0 | 23.3 | 27k | 20% |
| | 25EO | | NNDMA | | | | |
| 4 | 20 | 20 EHA | 60 MAA | 0 | 10.35 | 17k | 75-95% |
| | 16EO | | | | | | |
| 5 | 20 | 20 EHA | 60 MAA | 0 | 7.89 | 34k | 70-85% |
| | 25EO | | | | | | |
| 6 | 40 | 0 | 20 | 40 | 11.46 | 30k | |
| | 16EO | | NNDMA | MAA | | | |
| 7 | 36 | 0 | 32 | 32 | 26.6 | 100k | |
| | 25EO | | NNDMA | 2-HEA | | | |
| 8 | 30 | 0 | 30 | 40 | 5.6 | 30k | |
| | 25EO | | NNDMA | MAA | | | |

Stain Release Index (SRI)

The intensity of any stain can be measured by means of a reflectometer in terms of the difference between the stain and clean cloth giving ΔE* for each stain. It is defined as ΔE* and is calculated as shown below

$$Δ {E}^{*} = \sqrt{\begin{matrix}{( {L}_{stain \text{-} before}^{*} - {L}_{clean \text{-} cloth}^{*} )}^{2} + {( {a}_{stain \text{-} before}^{*} - {a}_{clean \text{-} cloth}^{*} )}^{2} + \\ {( {b}_{stain \text{-} before}^{*} - {b}_{clean \text{-} cloth}^{*} )}^{2}\end{matrix}}$$

This can be measured before and after the stain is washed, to give ΔE*bw and ΔE*aw.

SRI is a measure of how much of the stain is removed and is calculated by the expression:

SRI=100−ΔE*aw

A SRI of 100 means complete stain removal.

Table 2 gives the composition of a laundry detergent composition suitable for dosing at 20 ml per wash to a standard European front loading automatic washing machine with a capacity of 6 kg (approximately 10 litre fill).

TABLE 2
Laundry Detergent composition

| | % |
|---|---|
| Raw Material | solids |
| Glycerol | 5.00 |
| MPG | 15.00 |
| NI 7EO | 12.74 |
| LAS acid* | 9.07 |
| Fatty Acid* | 3.33 |
| SLES 3EO | 4.24 |
| Perfume | 2.43 |
| SRP** | See below |
| Savinase ultra | 1 |
| Water and minors | To 100 |

*LAS acid and fatty acid was neutralised with 47% NaOH. Amounts given are the acids.
**The soil release polymer (SRP) was included in the composition in an amount that was calculated dosed as solids (rather than active polymer). It should be noted that not all the polymer samples were 100% polymer. Thus the effects are better than these tests would appear to indicate. Tests on the unreacted monomer show that is the polymer component that is responsible for the soil release properties observed.

SRP—Synthesis

The soil release polymers for use in the composition may be manufactured using techniques familiar to those skilled in the art. An exemplary method to make polymer 6 is given below.

1) Reaction of Soprophor TS/16 with Methacrylic Anhydride to Produce Methacrylate Tris Ester (16EO)

TABLE 3

| | | Mol. | | |
|---|---|---|---|---|
| Reagent | Description | Wt. | Moles | Theo. Wt. |
| Soprophor TS/16 | Rhodia 104376-75-2 | 1192 | 0.185 | 220.00 |
| Methacrylic anh. 97% | Ald. S47713-199 | 154 | 0.221 | 35.13 |
| Sodium Acetate | MFG 6-17-09 | | | 1.28 |
| MEHQ | MFG 6-17-09 | | | 0.38 |
| Total | | | | 256.79 |

Reagents are as specified in Table 3

Procedure:

Charge Soprophor into a round bottomed flask and begin stirring and heating. Add MEHQ and sodium acetate. When temperature reaches 63° C., add 20 mol % excess anhydride slowly from a beaker. Mild exotherm may occur—keep below 70° C. Set to 63 to 65° C. React for 5 hr. Vacuum distil product post-reaction to reduce residual acid to ˜1%. Product is tris ester 16EO.

2) Copolymerisation to Synthesise Polymer 6

Reagents and process steps are as specified in table 4.

TABLE 4

| | | | gms | gms × ⅓ | mol % | weight % | |
|---|---|---|---|---|---|---|---|
| RC Δreflux | | | | | | | |
| DI Water | | | 150.0 | 75.00 | | 20.61 | Heat to |
| | | | | | | | reflux |
| | | | | | | | ~82 to |
| | | | | | | | 85 C. |
| Isopropanol | | | 150.0 | 75.00 | | 20.61 | |
| Monomer Feed (90 min) | | | | | | | |
| Isopropanol | | | 75.0 | 25.00 | | 10.30 | |
| DI Water | | | 126.0 | 42.00 | | | |
| tris Ester 16EO | From | | 126.0 | 42.00 | 40 | 17.31 | |
| | 1) | | | | | | |
| N,N Dimethylacrylamide | | | 4.95 | 1.65 | 20 | 0.68 | |
| methacrylic acid | | | 6.89 | 2.30 | 40 | 0.95 | |
| Initiator Feed (90 min) | | | | | | | |
| DI Water | | | 45.0 | 30.00 | | 6.18 | |
| Sodium Persulfate(7.0 mol %) | | | 4.17 | 1.39 | | 0.57 | |
| Scavenge Step (10 min) | | | | | | | |
| DI Water | | | 20.00 | 10.00 | | | |
| Sodium Persulfate | | | 0.42 | 0.14 | | | |
| Post Add (During Distillation) | | | | | | | |
| NaOH, 50% | | | 6.89 | 2.30 | | 0.95 | |
| DI Water | | | 150.00 | 50.00 | | | |
| Distillation | | | | | | | |
| Remove | | (−) | 337.5 | 150.00 | (−) | 46.37 | |
| Add | | (+) | 200 | 200.00 | (+) | 27.48 | |
| | | total = | 727.81 | 406.77 | | 100.00 | |
| | | solids % = | 19.78 | 11.83 | | | |

### Examples 1 to 4

### Primary Detergency at 40° C.

Wash Conditions

| | |
|---|---|
| Machine | Computerised Washing Machine |
| Wash Cycle | White Cotton 40° C. |
| Water Hardness | 24° FH (Ca:Mg 4:1) |
| Water Volume | 10 Litre |
| Dispensing | Pre dispersion via drawer |
| Ballast | 1.5 kg mixed load (30% WC, 30% KP and 40% PC) |
| Rinses | 2 |
| Replicate washes | 6 |
| Stained Monitors | Polyester and cotton: stains as specified below. |

WC is woven cotton; KP is knitted polyester; and PC is woven 50/50 polyester cotton.

Compositions Used

Comparison: Laundry detergent base laundry detergent composition given in Table 2

Example 1: Laundry detergent base+150 ppm Polymer 1

Example 2: Laundry detergent base+150 ppm Polymer 2

Example 3: Laundry detergent base+75 ppm Polymer 2

Example 4: Laundry detergent base+150 ppm Polymer 3

In these examples the laundry detergent base is the concentrated aqueous liquid detergent composition given in Table 2, which was dosed at 20 ml to give an active wash liquor surfactant concentration of 0.4 ml/litre. SRP is added to this for as specified for Examples 1 to 4. The values given are the differences in soil release index (at 95% confidence) between the monitor washed in the composition comprising the soil release polymer of the example and the base composition without any soil release polymer.

### Example 1

Enzymatic Stains

| | |
|---|---|
| Pigment/oil/milk on cotton (C10) | +2 |
| Aged blood CS01 | +3 |
| Potato starch CS27 | +3 |
| Cocoa, sugar, milk E112 | +2 |
| Grass on cotton | +3.5 |
| Grass on polyester | +2.5 |

Fatty Stains

| | |
|---|---|
| Lipstick on polyester | +1 |
| Ragu on polyester | +1 |
| Lanolin 30C on polyester | +4 |

### Example 2

Enzymatic Stains

| | |
|---|---|
| Grass on cotton | +4 |
| Grass on polyester | +3 |

Fatty Stains

| | |
|---|---|
| Lanolin 30C on polyester | +3 |
| Ragu on polyester | +1 |

### Example 3

Enzymatic Stains

| | |
|---|---|
| Pigment/oil/milk on cotton (C10) | +1 |
| Potato starch on cotton (CS27) | +2 |
| Grass on cotton | +4 |
| Grass on polyester | +2.5 |

Fatty Stains

| | |
|---|---|
| Lipstick on polyester | +1 |
| Ragu on polyester | +1 |
| 30C-lanolin on polyester | +2 |

### Example 4

Enzymatic Stains

| | |
|---|---|
| Pigment/oil/milk on cotton C10 | +1.5 |
| Potato starch on cotton CS27 | +2 |
| Grass on cotton | +4 |
| Grass on polyester | +3 |
| Gravy on polyester | +1 |

Fatty Stains

| | |
|---|---|
| Pigment/oil on cotton C09 | +1 |
| Sebum/pigment on polycotton 20D | +2 |
| Lipstick on polyester | +1.5 |
| Ragu on polyester | +1.5 |

### Example 5

### Pre Wash

Wash Conditions

| Machine | Computerised Washing Machine |
|---|---|
| Wash Cycle | White Cotton 30° C. |
| Water Hardness | 24° FH (Ca:Mg 4:1) |
| Water Volume | 10 Litre |
| Dispensing | Pre dispersion via drawer |
| Ballast | 1.5 kg mixed load (30% WC, 30% KP and 40% PC) |
| Rinse | 2 |
| Replicate washes | 6 |

Detergent composition of Table 2 dosed at 20 ml

Clothes washed 4 times with Base plus 150 ppm Polymer 3 compared with base alone. Results are improvement in SRI over base at 95% significance.

Fatty Stains on Polyester

| | |
|---|---|
| Cooking oil (dyed) | +6 |
| Dende oil | +3.5 |
| Dirty motor oil | +1.5 |
| Green curry | +2 |
| Lard (dyed) | +4 |
| Lipstick | +6.5 |
| Mechanical grease | +2.5 |
| Ragu | +1 |
| Red pepper oil | +4 |
| 30C lanolin | +1.5 |

Fatty Stains on Cotton

| | |
|---|---|
| Lipstick | +15.5 |
| Sebum | +4 |

### Example 6

### Primary Detergency at 30° C.

Wash Conditions

| Machine | Computerised Washing Machine |
|---|---|
| Wash Cycle | White Cotton 30° C. |
| Water Hardness | 24° FH (Ca:Mg 4:1) |
| Water Volume | 10 Litre |
| Dispensing | Pre dispersion via drawer |
| Ballast | 1.5 kg mixed load (30% WC, 30% KP and 40% PC) |
| Rinse | 2 |
| Replicate washes | 6 |

Detergent composition of Table 2 dosed at 20 ml. Results are improvement in SRI of Base plus 150 ppm Polymer 3 over base at 95% significance.

Fatty Stains on Polyester

| | |
|---|---|
| Cooking oil (dyed) | +3 |
| Dende oil | +3 |
| Lipstick | +6.5 |
| Ragu | +3.5 |
| Red pepper oil | +5.5 |
| Tomato oil | +2.5 |

Fatty Stains on Cotton

| | |
|---|---|
| Lipstick | +20 |

### Example 7 and Comparative Example A

Base is composition of table 2. Comparative example A is base with 150 ppm Texcare SRN 170 a Polyester based SRP. Example 7 is base plus 150 ppm polymer 3.

Primary

Wash protocol as Example 6.

Fabrics washed 4 times before applying stain.

Fabrics then re-washed as per Example 6 protocol

Detergent composition of Table 2 dosed at 20 ml.

Pre Wash

As Example 5

Results

Results are summarised in Table 5. Values are SRI improvement versus base with no polymer. SRI diff shows the difference between Example 7 and comparative example A.

TABLE 5

| | | | 7 | A | SRI diff |
|---|---|---|---|---|---|
| rimary | stain | fabric | | | |
| | lipstick | cotton | 20.0732 | 4.7145 | +15.3587 |
| | lipstick | PE | 6.57655 | 2.8643 | +3.71229 |
| | sebum | cotton | 2.18625 | −1.0737 | +3.25994 |
| | yellow | cotton | 1.36168 | 0.0286 | +1.33305 |
| | curry | | | | |
| | yellow | PE | 0.21386 | 0.2207 | −0.0068 |
| | curry | | | | |
| prewash | lipstick | cotton | 15.6487 | 3.7782 | +11.8706 |
| | lipstick | PE | 6.97499 | 6.1655 | +0.80954 |
| | sebum | cotton | 3.7041 | 0.9016 | +2.80253 |
| | yellow | cotton | 1.27766 | −0.6242 | +1.90185 |
| | curry | | | | |
| | yellow | PE | −0.14104 | 0.0199 | −0.16098 |
| | curry | | | | |

### Example 8

### Lard Stained Fabric Tergo Washes

Methodology

All washes were conducted at 30° C. using wash water at 24° FH. Six replicate washes were conducted for each formulation—one in each pot.

Stain

Cotton: Lard+dye

Polyester: Lard+dye

Phase 1: Primary Detergency and Prewashing

Stained PE fabric samples were prepared. These stained samples were then washed in the Tergo with sufficient ballast to make up a liquor to cloth ratio of 30:1. This ballast contained the cloths which would later be stained for the multiwash phase of the test. The ballast for each formulation was re-used for each of the 6 replicate washes for that formulation

Phase 2: Multiwash Detergency

After conducting the 6 replicate primary washes, the pre-wash cloths in the ballast were stained in the same way and then a wash was conducted with these stained cloths (again with the same ballast) but with some new pieces of cotton and PE to make up the correct liquor to cloth ratio. Results are summarised in table 6.

TABLE 6

| | PREWASH | PRIMARY |
|---|---|---|
| | LSM SRI | LSM SRI |
| Stain = Lard on PE | | |
| Control - surfactant | 51.6 | 51.8 |
| Control polymer | 48.9 | 57.4 |
| SRN170 | | |
| Polymer 4 | 84.5 | 47.0 |
| Polymer 5 | 79.9 | 51.2 |
| Stain = Lard on cotton | | |
| Control - surfactant | 75.8 | 57.5 |
| Control polymer | 66.6 | 55.8 |
| SRN170 | | |
| Polymer 4 | 74.9 | 52.3 |
| Polymer 5 | 65.4 | 57.8 |

Polymer 4 shows great difference in cleaning from primary to pre-wash (+22.6) vs. surfactant control (+18.3)

### Example 9

### Primary Detergency Effect with EPEI

TABLE 7
Detergent compositions 9A and 9B

| | 9A | 9B |
|---|---|---|
| | % | % |
| Raw Material | solids | solids |
| MPG | 16.5 | 16.5 |
| TEA | 1.5 | 1.5 |
| NI 7EO | 6.0 | 6.0 |
| LAS acid* | 4.1 | 4.1 |
| Fatty Acid* | 0.7 | 0.7 |
| SLES 3EO | 2.8 | 2.8 |
| Empigen BB | 0 | 0.7 |
| Perfume | 1.1 | 1.1 |
| SRP** | See below | See below |
| EPEI | 0 | 2.6 |
| Water and minors | To 100 | To 100 |

Wash Conditions

| Machine | Computerised Washing Machine |
|---|---|
| Wash Cycle | White Cotton 40° C. |
| Water Hardness | 24° FH (Ca:Mg 4:1) |
| Water Volume | 10 Litre |
| Dispensing | Pre dispersion via drawer |
| Ballast | 1.5 kg mixed load (30% WC, 30% KP and 40% PC) |
| Rinse | 2 |
| Replicate washes | 6 |

Detergent compositions 9A or 9B of table 7, dosed at 45 ml

40° C. wash Miele FLA—primary detergency.

Example shows the effect on particulate stain removal of the SRP technology, 100 ppm of EPEI was added to the bases which contained Polymer 7 or Polymer 8. Results are given in table 8.

TABLE 8

| | | | |
|---|---|---|---|
| | | | SRI difference (Base with |
| | | | polymer 9B (inc EPEI) |
| | | | minus base with polymer |
| | | | 9A) |
| | | | Δ = SRI_{(Polymer base+EPEI)} − |
| Polymer base | stain | Fabric | SRI_{(polymer base)} |

| | | | |
|---|---|---|---|
| SRN170 | Yellow pottery | cotton | 0.4 |
| | clay | | |
| Polymer 7 | | | 1.9 |
| Polymer 8 | | | 2.1 |
| SRN170 | Yellow pottery | PE | 4.5 |
| | clay | | |
| Polymer 7 | | | 7.9 |
| Polymer 8 | | | 8.7 |

### Example 10

### Pre Wash Effect with EPEI

Wash Conditions

| Machine | Computerised Washing Machine |
|---|---|
| Wash Cycle | White Cotton 30° C. |
| Water Hardness | 24° FH (Ca:Mg 4:1) |
| Water Volume | 10 Litre |
| Dispensing | Pre dispersion via drawer |
| Ballast | 1.5 kg mixed load (30% WC, 30% KP and 40% PC) |
| Rinse | 2 |
| Replicate washes | 6 |

Detergent composition 9A or 9B of Table 7, dosed at 45 ml.

Clothes washed 2 times with 100 ppm Polymers 7 and 8.

Example showing the effect on particulate stain removal of the SRP technology, 100 ppm of EPEI was added to the bases which contained polymers 7 or 8. Results are given in Table 9.

TABLE 9

| | | | |
|---|---|---|---|
| | | | SRI difference (Base with |
| | | | polymer 9B (inc EPEI) |
| | | | minus base with polymer |
| | | | 9A) |
| | | | Δ = SRI_{(Polymer base+EPEI)} − |
| Polymer base | stain | Fabric | SRI_{(polymer base)} |

| | | | |
|---|---|---|---|
| SRN170 | Yellow pottery | cotton | −0.4 |
| | clay | | |
| Polymer 7 | | | 0.7 |
| Polymer 8 | | | 2.2 |
| SRN170 | Yellow pottery | PE | 3.6 |
| | clay | | |
| Polymer 7 | | | 12.5 |
| Polymer 8 | | | 12.6 |

1. A detergent composition comprising 10 to 60 wt % detergent surfactant and 0.1 to 10 wt % of a soil release agent comprising a water soluble addition polymer having a backbone prepared from (meth)acrylic, vinylic and/or (meth)acrylamido and pendent di- and/or tri-styryl groups attached to the backbone via alkylene oxide spacer groups.

2. A composition according to claim 1 which is a liquid composition.

3. A composition according to claim 2 which comprises more than 25 wt % water.

4. A composition according to claim 1 which is alkaline when diluted in 500 times its own weight of demineralised water.

5. A composition according to claim 1 which is solid and comprises at least 5 wt % of a detergency builder system.

6. A composition according to claim 5 which is solid and wherein the builder system comprises sodium carbonate.

7. A composition according to claim 1 in which the soil release agent is a polymer comprising from 2 to 50 mol % di and/or tristyryl groups.

8. A composition according to claim 7 in which the polymer comprises at least 3 mol % tri-styryl groups.

9. A composition according to claim 7 in which the spacer groups comprise an average of from 8 to 100EO moieties.

10. A composition according to claim 1 in which the Soil Release Polymer (SRP) is formed from at least two monomers selected from the group consisting of: tristrylphenol ethoxylate methacrylate, tertiary butyl amino ethyl methacrylate, ethyl hexyl acrylate, N,N,dimethylacrylamide, hydroxyethyl acrylate and methacrylic acid, acrylic acid.

11. A composition according to claim 1 wherein the polymer comprises sulphonated monomers.

12. A composition according to claim 1 which further comprises a component selected from the group consisting of an ethoxylated polyethyleneimine, protease enzyme, betaine surfactant, at least 2 wt % perfume, and mixtures thereof.

13-15. (canceled)

16. A soil release agent for detergent compositions, said agent comprising a water soluble addition polymer having a backbone prepared from (meth)acrylic, vinylic and/or (meth)acrylamido and pendent di- and/or tri-styryl groups attached to the backbone via alkylene oxide spacer groups.

17. The soil release agent of claim 16 wherein said polymer comprises from 2 to 50 mol % di and/or tristyryl groups attached to the polymer backbone via alkoxy spacer groups.

18. The soil release agent according to claim 17 in which the polymer comprises at least 3 mol % tri-styryl groups.

19. The soil release agent according to claim 18 in which the spacer groups comprise an average of from 8 to 100EO moieties.

20. A method of treatment of textiles to confer improved soil release, said method comprising treating said textile with soil release agent according to claim 19.

21. A composition according to claim 1 where the alkylene oxide spacer groups are ethylene oxide groups.

22. A composition according to claim 1 where the alkylene oxide groups are 14 to 30 alkylene oxide groups.

23. A composition according to claim 1 where the tri-styryl group is try-styryl phenyl.

24. A soil release agent according to claim 16 where the alkylene oxide spacer groups are ethylene oxide groups.

25. A soil release agent according to claim 16 where the alkylene oxide groups are 14 to 30 alkylene oxide groups.

26. A soil release agent according to claim 16 where the tri-styryl group is try-styryl phenyl.
